(19) United States
(12) Patent Application Publication
(10) Pub. No.: US 2026/0104552 A1
(43) Pub. Date: Apr. 16, 2026

(54) Mass Ganging of VSFF Fiber Optic Connectors with Dust Protection Cap Having an Eye Loop

(71) Applicant: US Conec Ltd., Hickory, NC (US)

(72) Inventors: Jason Higley, Hickory, NC (US); Charles Gregory Stroup, JR., Lincolnton, NC (US); Darrell R. Childers, Hickory, NC (US)

(21) Appl. No.: 19/358,857

(22) Filed: Oct. 15, 2025

Related U.S. Application Data
(60) Provisional application No. 63/707,601, filed on Oct. 15, 2024.

(51) Int. Cl. G02B 6/38

(52) U.S. Cl. CPC G02B 6/3823; G02B 6/3849; G02B 6/387; G02B 6/3897

(57) ABSTRACT

A combination of a carrier and a dust cap for at least two fiber optic connectors includes a carrier, a dust cap, and a pulling structure adjacent the closed end of the dust cap and extending away from the open end, at least one attachment mechanism to couple the dust cap to the carrier, wherein the at least one attachment mechanism is in a stressed position when the carrier and the dust cap are secured to one another.

### REFERENCE TO RELATED CASE

This application claims priority under 35 U.S.C. § 119 (e) to U.S. provisional application No. 63/707,601 filed on Oct. 15, 2024, the contents of which are hereby incorporated by reference in their entirety.

### BACKGROUND OF THE INVENTION

Fiber optic connectors, e.g., Very Small Form Factor (VSFF) fiber-optic connectors (“VSFF connectors”) are sometimes used in ganged configurations. One such example of ganging is provided in Patent Application No. PCT/US25/18447, titled “Mechanical Advantage Extraction of VSFF Mass Insertion Connector Solutions” filed Mar. 5, 2025 (Atty. Dkt. No. USCO-183-INT) by the Applicant, incorporated herein by reference in its entirety. Yet another example of ganging of fiber optic adapters for LC type connectors is described in U.S. Pat. No. 10,281,672 where a cassette holds together several adapters that then receive LC-type connectors once the adapters are secured to a rack. However, the cassette does not directly interface with any ganged group of fiber optic connectors.

There are situations when such a ganged arrangement of connectors needs to be moved as a group, or routed, from one location within a data center to an end point (e.g., to a back panel of a server in the data center). Sometimes, this ganged arrangement has to simply sit for a while, in which case, a dust cap arrangement, whether individual dust caps, or a ganged common dust cap needs to be attached to cover the end faces of the individual VSFF connectors. Eventually, prior to connecting this ganged VSFF connector assembly, the dust cap has to be removed, which requires a substantial force to be applied by the end user. The force multiples as the number of VSFF connectors that are ganged increases (e.g., two VSFF connectors to six VSFF connectors). One challenge in the industry is how to reduce this force required by the end user while still maintaining a robust attachment between the dust cap and the ganged VSFF connector assembly.

Conventional ganging mechanisms for VSFF connectors rely on a carrier that is common to all connectors. One such carrier is illustrated in International Patent Application No. PCT/US24/47221 (Atty. Dkt. USCO-175-INT, hereinafter “the '221 application,” also published as WO 2025/064510) filed on Sep. 18, 2024, incorporated herein by reference in its entirety. The carrier latches to the latching mechanism of the individual VSFF connectors. In conventional systems, this force between the carrier and the latching mechanism of the individual VSFF connectors is a limiting factor in ensuring robustness of attachment of the carrier to the ganged assembly, and hence, is a limitation on the accompanying dust cap that attaches to the carrier. On the other hand, any coupling mechanism also has to ensure that the end user has to apply a manageable force for every such ganged VSFF connector assembly without causing serious ergonomic issues, e.g., when taking the dust cap off the assembly to make optical connections for several such ganged VSFF connectors successively or multiple times.

### SUMMARY OF THE INVENTION

According to one aspect, the present invention is directed to a combination of a carrier and a dust cap for at least two fiber optic connectors that includes a carrier having a carrier main body formed by two long sides of the carrier bound by two opposing short sides of the carrier and having a main opening along a longitudinal axis between a first side and a second side for receiving the at least two fiber-optic connectors therein, a dust cap having a dust cap main body with an open end and a closed end separated along the longitudinal axis, the dust cap main body formed by two long sides bound by two opposing short sides and the closed end, the open end configured to receive at least a portion of the carrier and a portion of the at least two fiber optic connectors, a pulling structure adjacent the closed end of the dust cap and extending away from the open end, at least one attachment mechanism to couple the dust cap to the carrier.

In some embodiments, the at least one attachment mechanism includes a lever rotatably attached to the dust cap and at least one post on the carrier to couple to an end portion of the lever.

In some embodiments, the at least one attachment mechanism includes at least one cantilevered beam on the dust cap main body of the dust cap and extending away from the open end and the closed end, and wherein the carrier comprises at least one post to couple to the at least one cantilevered beam.

In some embodiments, the at least two fiber optic connectors comprise at least six fiber optic connectors, and wherein the dust cap and the carrier each further comprise an internal wall, respectively, to separate three of the at least six fiber optic connectors from the remaining fiber optic connectors in the at least six fiber optic connectors

In some embodiments, the internal wall of the carrier is connected to the two long sides of the carrier, and the internal wall of the dust cap is connected to the two long sides of the dust cap.

In some embodiments, the carrier includes receptacles to respectively receive latches of the at least two fiber optic connectors to secure the at least two fiber optic connectors to the carrier.

In some embodiments, an end face of a fiber optic ferrule of each of the at least two fiber optic connectors is fully enclosed by the dust cap main body when the carrier is secured to the dust cap.

In some embodiments, there is a shroud having a main body with an opening to receive at least a portion of the dust cap and the carrier together.

In some embodiments, the pulling structure is outside the opening of the shroud.

In yet another aspect, there is a combination of a carrier and a clam shell pulling eye for at least two fiber optic connectors that includes a carrier formed by two long sides bound by two opposing short sides and having a second main opening along a second longitudinal axis between a first side and a second side of the main body for receiving the at least two fiber-optic connectors, a clam shell pulling eye having a main body to fully enclose the carrier and respective housings of the at least two fiber optic connectors, the main body of the clam shell pulling eye having an open end and a closed end separated along a longitudinal axis when two pieces of the clam shell pulling eye are joined together, a pulling structure attached to the closed end of the clam shell pulling eye and extending away from the open end, and at least one shoulder adjacent the open end of the clam shell pulling eye, the at least one shoulder commonly enclosing respective boots of the at least two fiber optic connectors.

In some embodiments, there also is a dust cap having a dust cap main body with a dust cap open end and a dust cap closed end separated along the longitudinal axis, the dust cap main body formed by two long sides bound by two opposing short sides and configured to receive at least a portion of the carrier and the at least two fiber optic connectors at the dust cap open end.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a top perspective view of one embodiment of a combination of a carrier and a dust cap according to the present invention;

FIG. 2 is a bottom perspective view the carrier and the dust cap in FIG. 1;

FIG. 3 is a top perspective view of the carrier with fiber optic connectors of FIG. 1;

FIG. 4 is top plan view of the carrier removed from the dust cap in FIG. 1;

FIG. 5 is a top view of the carrier and the dust cap in FIG. 1;

FIG. 6 is a partial cross sectional view of the carrier and the dust cap;

FIG. 7 is a front elevational view of the carrier with the fiber optic connectors and the dust cap in FIG. 1;

FIG. 8 is a cross section view of the carrier in FIG. 1 through one of the fiber optic connectors;

FIG. 9 is a perspective view of the carrier in FIG. 1 with the fiber optic connectors removed;

FIG. 10 is a perspective view of the carrier in FIG. 1.

FIG. 11A is a perspective view from the front of one embodiment of a dust cap according to the present invention;

FIG. 11B is a perspective view from behind the dust cap in FIG. 11A;

FIG. 12 is a elevational view from behind the dust cap in FIG. 11A;

FIG. 13 is a partial cross sectional view of dust cap in FIG. 11A;

FIG. 14 is a perspective view of the combination of the carrier and the dust cap in FIG. 1 with one embodiment of a shroud according to the present invention;

FIG. 15 is a perspective view of the combination of the carrier and the dust cap in FIG. 15 with the shroud being transparent;

FIG. 16 is an elevational view of the shroud in FIG. 14 from behind;

FIG. 17 is a perspective view of another embodiment of a combination of a carrier and a dust cap according to the present invention;

FIG. 18 is a rear perspective view of the dust cap in FIG. 17;

FIG. 19 is a perspective view from the top right of the dust cap in FIG. 17;

FIG. 20 is a perspective view of another embodiment of a combination of a carrier and a clam shell according to the present invention;

FIG. 21 is a side perspective view of a portion of the clam shell removed showing the carrier and fiber optic connectors;

FIG. 22 is a partial rear perspective view of a partial cross section of the combination with the carrier and the fiber optic connectors;

FIG. 23 is an elevational view of a partial cross section of the clam shell with the fiber optic connectors; and

FIG. 24 is a perspective view of the bottom portion of the clam shell.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

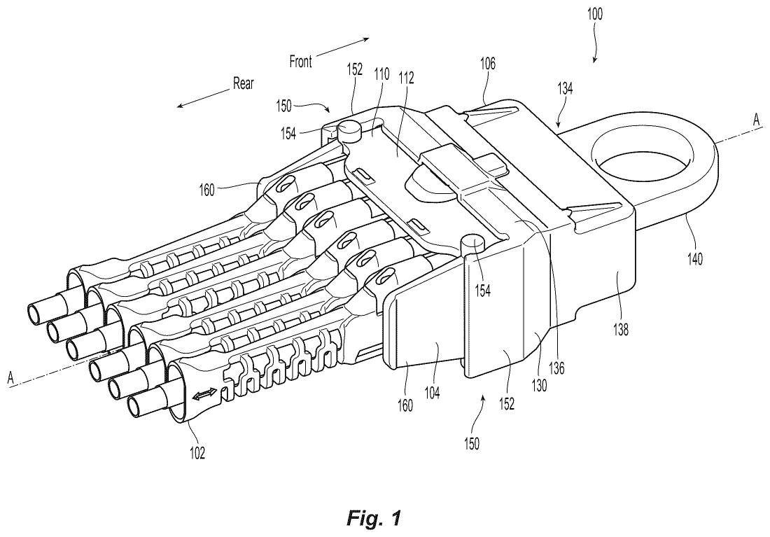

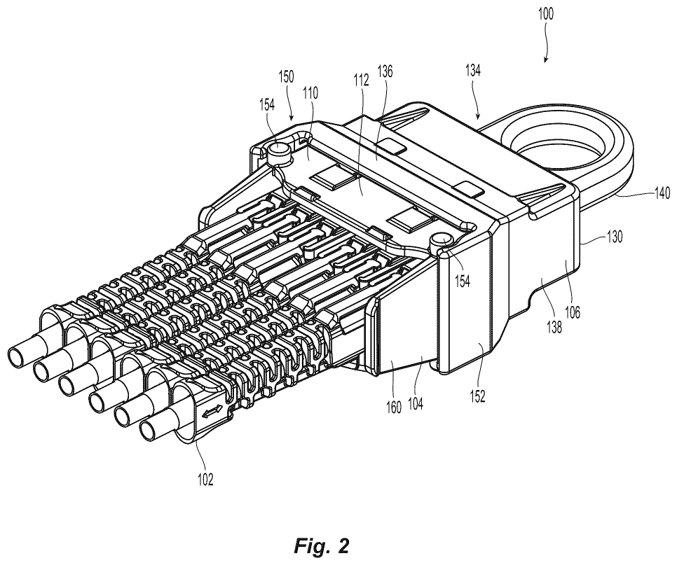

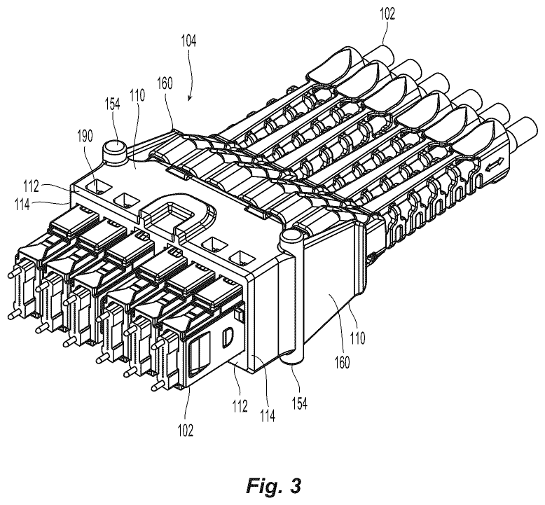

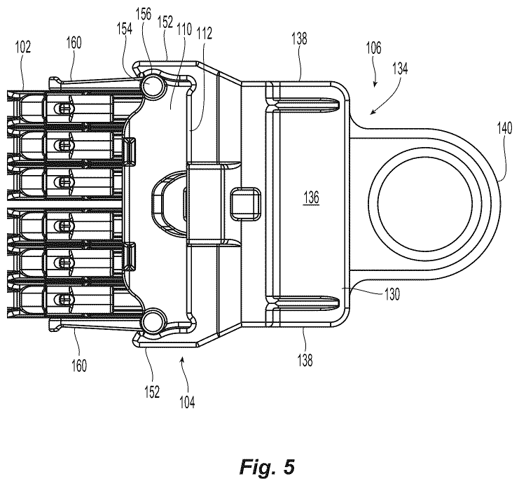

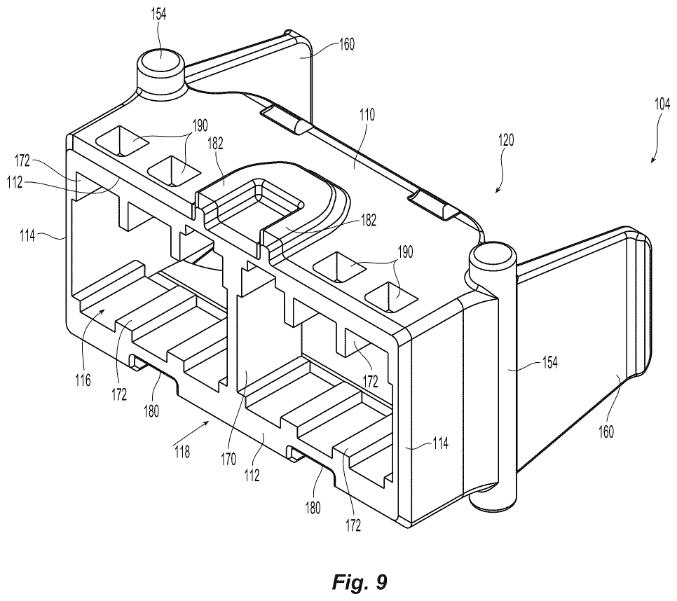

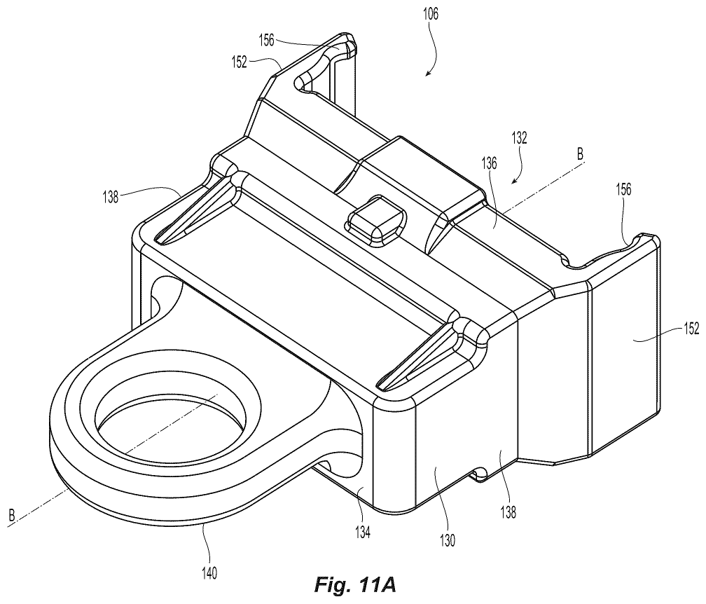

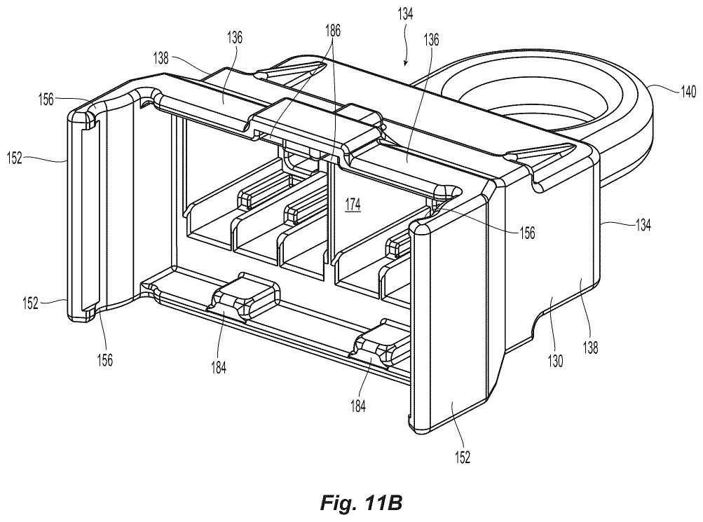

Illustrated in FIGS. 1-8 there is one embodiment of a combination of a carrier and a dust cap 100 for at least two fiber optic connectors 102 according to the present invention. As illustrated, there can be up to 6 fiber optic connectors 102 in the combination 100 that are to be protected. However, there may also be fewer than 6 usually in denominations of 2—so 2, 4, or 6—or, more than 6, e.g., 8. The combination 100 includes a carrier 104 (fiber optic connector carrier) and a dust cap 106. See also FIGS. 9 and 11A, respectively. The carrier 104 has a carrier main body 110 formed by two long sides 112 of the carrier 104 bound by two opposing short sides 114 of the carrier 104. The carrier 104 also has a main opening 116 along a longitudinal axis A between a first side 118 and a second side 120 for receiving the at least two fiber-optic connectors 102 therein. See FIGS. 3, 4, 7, and 9.

Applicant notes that the term “front” or “forward” means that direction where the fiber optic ferrule would meet with another fiber optic ferrule or device, while the term “rear” or “rearward” is used to mean the direction from which the optical fibers enter into the fiber-optic ferrule or fiber optic connector. In the present application, the combination of a carrier and a dust cap for at least two fiber optic connectors 102 will therefore have a front and a rear. Thus, in FIG. 1, the “front” of combination of a carrier and dust cap for at least two fiber optic connectors 102 is on the right side of the figure and pointing into the figure. The “rear” or “back” is the part of the combination of a carrier and a dust cap for at least two fiber optic connectors 102 that is on the left side of the page and “rearward”and “backward”is toward the left and out of the page.

The combination 100 also has the dust cap 106 having a dust cap main body 130 with an open end 132 and a closed end 134 separated along the longitudinal axis B.

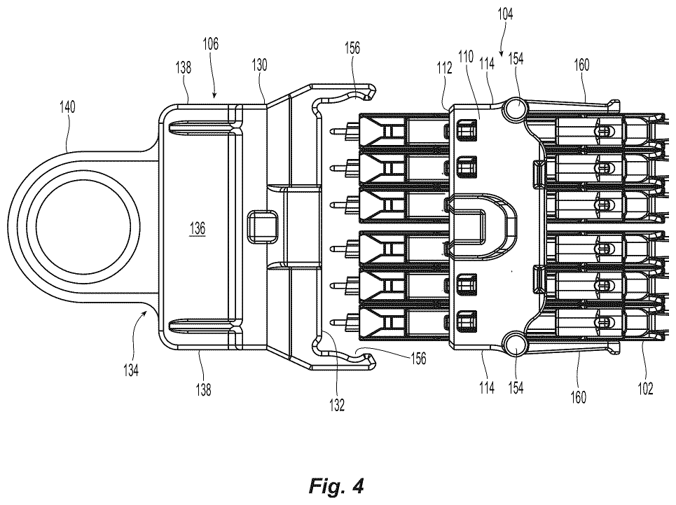

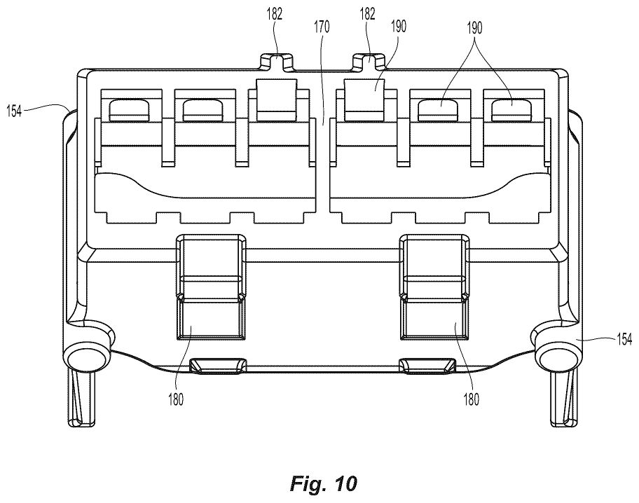

See, e.g., FIG. 11A. The longitudinal axes A and B can be, and in this case, are the same. However, they may also be different. The dust cap main body 130 is formed by two long sides 136 bound by two opposing short sides 138 and the closed end 134. The open end 132 is configured to receive at least a portion of the carrier 104 and a portion of the at least two fiber optic connectors 102. The dust cap 106 has a pulling structure 140 adjacent the closed end 134 of the dust cap 106 and extending away from the open end 132. See FIGS. 4 and 10-13. While illustrated as a loop or complete circle, the pulling structure 140 may have discontinuities in the shape to allow for attachment by other elements, such as a rope, etc. that can be slid onto the pulling structure 140 rather than looped through it. The pulling structure 140 allows for the combination 100 along with the at least two fiber optic connectors 102 to be pulled through one or more conduits, e.g., inside a data center without the fiber optic connectors 102 coming off the carrier 104, the dust cap 106, or both.

The combination 100 also includes at least one attachment mechanism 150 to couple the dust cap 106 to the carrier 104. The at least one attachment mechanism 150 includes a portion of the dust cap 106 and a portion of the carrier 104. More specifically, in this embodiment, the at least one attachment mechanism 150 includes at least one cantilevered beam 152 on the dust cap main body 130 that extends away from both the open end 132 and the closed end 134 thereof. It also includes at least one post 154 on the carrier 104 to elastically engage and couple to the at least one cantilevered beam 152.

The at least one attachment mechanism 150 is in a stressed position when the carrier 104 and the dust cap 106 are being secured to one another. That is, the at least one cantilevered beam 152 is biased against the at least one post 154 on the carrier 104 to secure the dust cap 106 to the carrier 104. Once attached to the post 154 though, the cantilevered beam 152 is not under stress.

There are preferably two cantilevered beams 152 on the dust cap 106, one of each of the two opposing short sides 138. While each of the two cantilevered beams 152 are illustrated running entirely between the two long sides 136, there may be shorter cantilevered beams that may each extend only partially between the two long sides 136. That would mean that there could be four cantilevered beams 152, two on each of the long sides 136.

There are also preferably two posts 154 on the carrier 104 (see, e.g. FIGS. 1, 3, 5, 7, and 9) that also extend between (and beyond) the long sides 136. The posts 154 may also be divided into two sections, providing four different portions of the posts 154. The posts 154 fit within a curved portion 156 of the cantilevered beams 152. See FIGS. 4, 5, and 11B. As noted above, the cantilevered beams 152 press against the posts 154 to hold the carrier 104 and the dust cap 106 together.

The carrier 104 may also have tab 160 on each of the short sides 114 to allow a user to manipulate the carrier 104. Each tab 160 extends rearward away from the main opening 116 of the carrier 104. The tabs 160 may be pushed toward each other to aid in release of the dust cap 106 from the carrier 104. Pushing the tabs 160 towards each other may loosen the posts 154 from the curved portion 156 of the cantilevered beam 152.

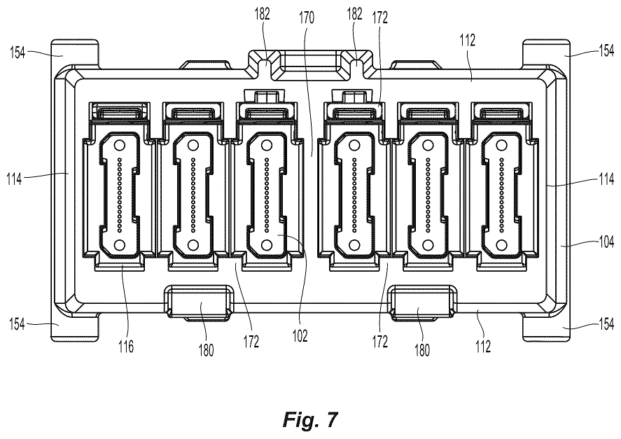

The carrier 104 may also have an internal wall 170 that separates the main opening 116 into separate portions. The internal wall 170 preferable extends from the two long sides 112 and is parallel to the fiber optic connectors 102 inserted there. As illustrated in the figures, the internal wall 170 divides the main opening 116 into two identical portions. However, the internal wall 170 may also be two internal walls, dividing the main opening 116 into three identical portions or into two portions that are different (4 and 2, for example). The internal wall 170 may also provide support to the carrier 104 and the long sides 112, and thus functions as a strength member. For a smaller number of fiber optic connectors 102 (e.g., 2), there may be no internal wall 170 provided. The main opening 116 may also include alignment features 172 that assist in the orientation/alignment of the fiber optic connectors 102. See FIGS. 7, 9, and 10. Generally, the alignment features 172 are projections into the main opening 116 that engage corresponding structures on the fiber optic connectors 102. The alignment features 172 may also be considered to be between two adjacent grooves or ports for the fiber optic connectors 102 and perform the same function.

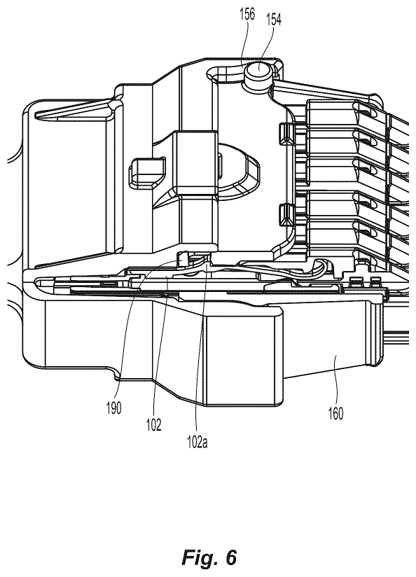

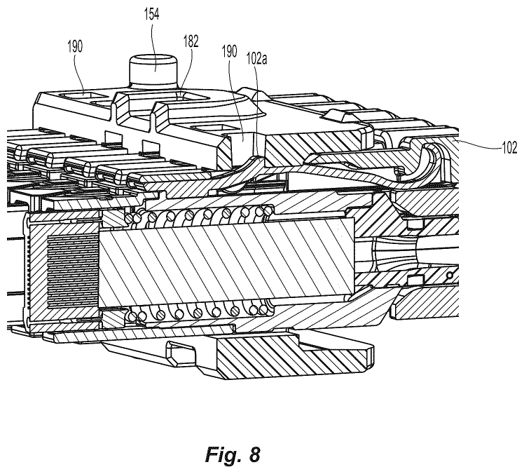

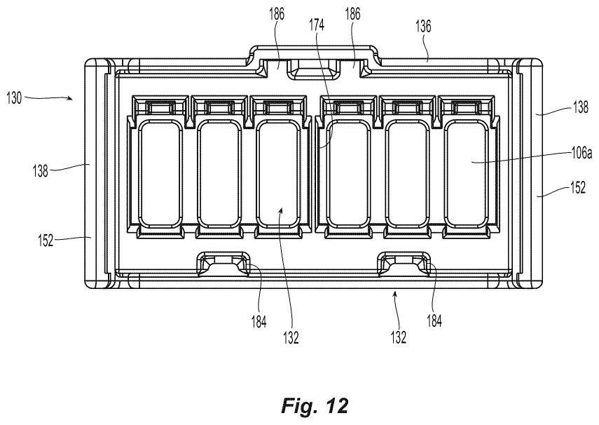

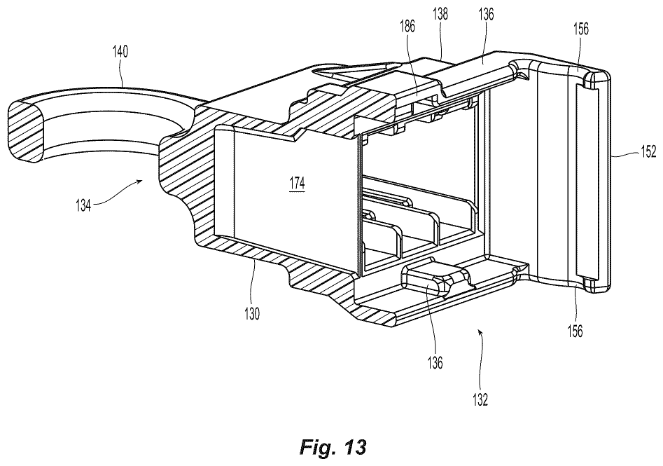

The dust cap 106 also has an internal wall 174 that divides the interior of the dust cap 106 in the same way as internal wall 170. Again, the internal wall 174 could be two walls or divide the dust cap into identical or different portions. Alternatively, for a smaller number of fiber optic connectors 102 (e.g., 2), there may be no internal wall 174 provided. The internal wall 174 extends between the two long sides 136. See also, FIG. 13. While not shown in FIG. 11B, the dust cap 106 may also have alignment features similar to the alignment features 172 to separate the fiber optic connectors 102 received inside the dust cap 106. At the front end of dust cap 106 are receptacles 106a to receive the front ends of each of at least two fiber optic connectors 102. See, FIG. 12 and also, FIG. 6. Thus the end faces of the fiber optic ferrule of each of the at least two fiber optic connectors 102 are fully enclosed by the dust cap main body 130 when the carrier is secured to the dust cap 106. See also FIG. 8 for a cross-section of the front end of the fiber optic connectors 102.

The combination 100 of the carrier 104 and the dust cap 106 also include features to align and retain the combination 100. The carrier 104 has two lower carrier pockets 180 along the bottom long side 112 and two upper carrier projections 182 on the top long side 112. See FIGS. 7, 9, and 10. The dust cap 106 has corresponding structures to engage those on the carrier 104. For example, the dust cap 106 has two dust cap projections 184 along the lower long side 136 that engage with the two lower carrier pockets 180 and two dust cap pockets 186 along the upper long side 136 to engage the two upper carrier projections 182. See FIGS. 9, 10, and 11B.

The fiber optic connectors 102 have latches 102a that are used to retain the fiber optic connectors 102 in the carrier 104. The latches 102a in the fiber optic connectors 102 are best illustrated in FIGS. 6 and 8. The latches 102a preferably have a section that extends upward and away from the fiber optic connectors 102. That section coincides with receptacles/recesses 190 in the carrier 104. See FIGS. 6, 8, and 9. This is the manner in which the fiber optic connectors 102 are connected to and stay connected to the carrier 104. Each of the fiber optic connectors 102 may be removed (individually or as a group) from the carrier 104 by releasing the latch 102a for a particular fiber optic connector 102. The latch 102a for a particular fiber optic connector 102 can only handle a limited amount of stress as the combination 100 is moved around or pulled around. Thus, various embodiments described herein distribute the stress on each of the latches 102a in the combination 100 via the dust cap 106, e.g., when the combination 100 is pulled. See, e.g., FIG. 6.

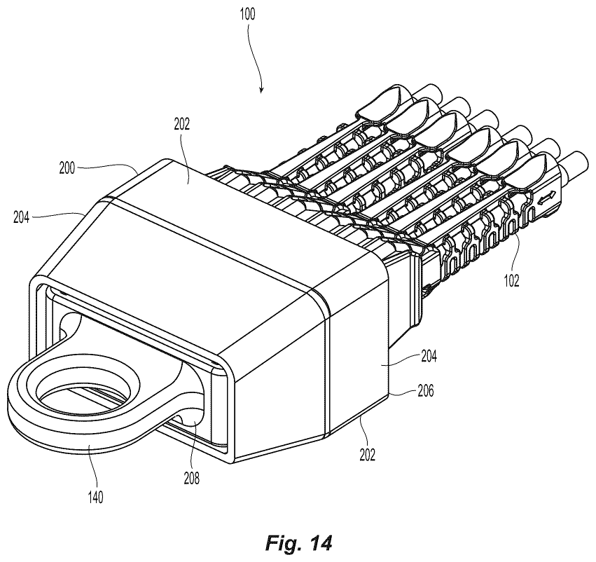

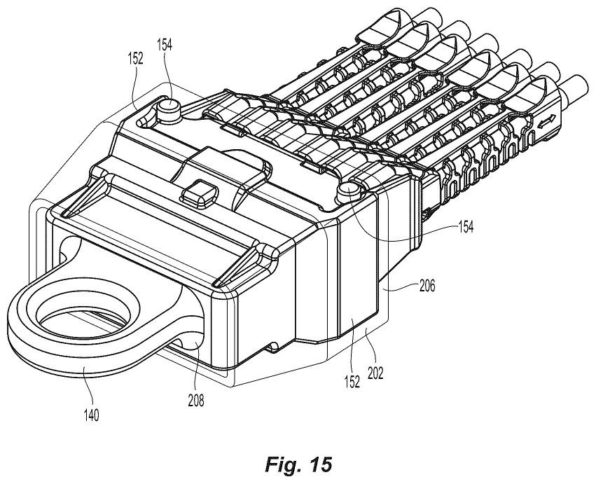

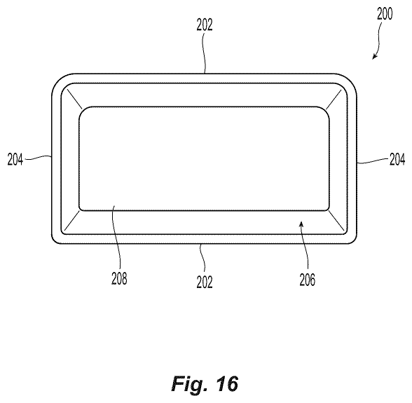

The combination 100 of the carrier 104 and the dust cap 106 may also have a shroud 200. See FIGS. 14-16. The shroud 200 is dimensioned to fit over the carrier 104 and the dust cap 106. The shroud 200 is, like the dust cap 106, formed by two long sides 202 and two opposing short sides 204 and has an open end 206 to receive the combination 100. At the other end of the shroud 200 is a smaller opening 208 that allows for the passage of the pulling structure 140. The shroud 200 provides additional strain relief to the combination 100 when the combination is pulled at the pulling structure 140 of the dust cap 106. This arrangement further distributes the forces encountered by the user and by the latches 102a during pulling the assembly so that accidental disengagement of any of the fiber optic connectors 102 from the carrier 104 is highly unlikely. Preferably the length of the shroud 200 covers the majority if not all of the dust cap 106. As illustrated in FIG. 15, the two opposing short sides 204 of the shroud 200 extend beyond the cantilevered beams 152 and two posts 154, essentially blocking the cantilevered beams 152 from moving outward and releasing the carrier 104.

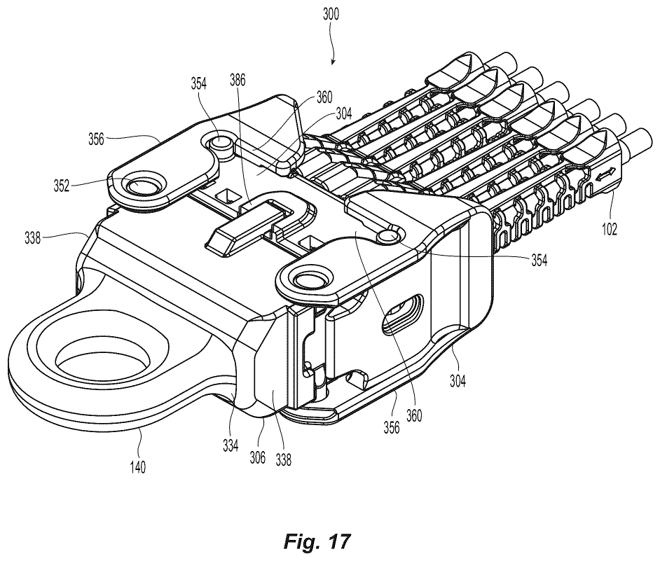

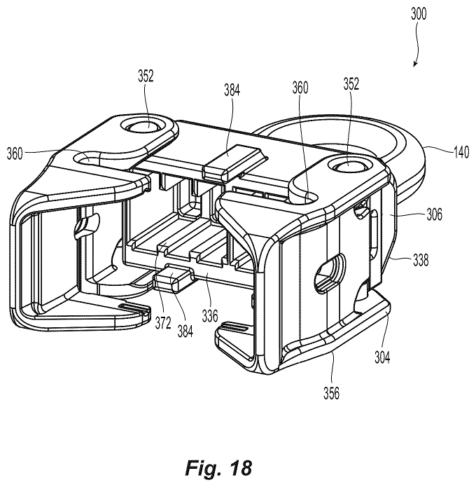

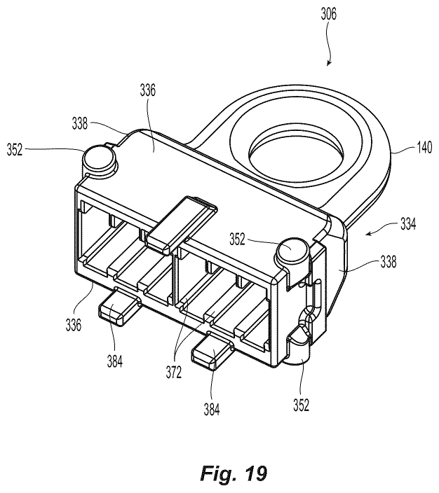

Another combination 300 a carrier and a dust cap for at least two fiber optic connectors is illustrated in FIGS. 17-19. In this combination 300, there is a carrier 304 (fiber optic connector carrier) and a dust cap 306. The dust cap 306 is formed by two long sides 336 bound by two opposing short sides 338 and the closed end 334. The dust cap 306 has posts 352 along each of the short sides 338 and partially contacting the long sides 336 to engage levers 356, although the posts 352 may alternatively be purely resident on the short sides 338 without overlapping with the long sides 336. As seen in FIG. 19, the dust cap 306 has alignment features 372 for the fiber optic connectors 102. There are also projections 384 on the dust cap 306 and pockets 386 to align the dust cap 306 and the carrier 304 together. The levers 356 are further described in detail in Applicant's WIPO Publication No. WO 2025/188824 (Atty. Docket USCO-183-INT, corresponding to PCT/US25/18447, filed Mar. 5, 2025), the contents of which are incorporated by reference herein in their entirety.

The carrier 304 is illustrated in FIG. 17 and has posts 354 which are used together with the levers 356 to engage and hold the dust cap 306 with the carrier 304. The levers 356 are rotated out of the way about the posts 352 to allow for the carrier 304 to be inserted into the dust cap 306. The levers 356 have a cutout 360 that engages the posts 354. As the levers 356 are rotated, the mechanical advantage of the levers 356 cause the carrier 304 to move toward and engage the dust cap 306 and be retained therein. Other features of the combination 300 (e.g., the pulling structure 140) are similar to those in the combination 100, and will not be described herein again.

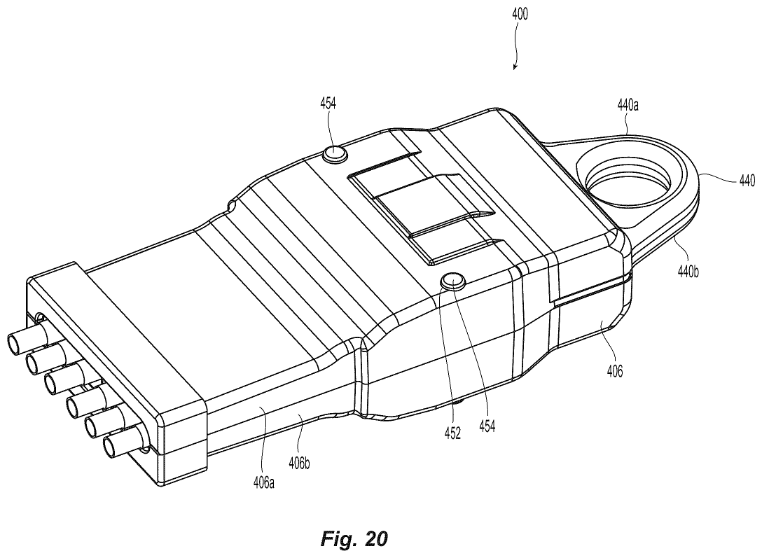

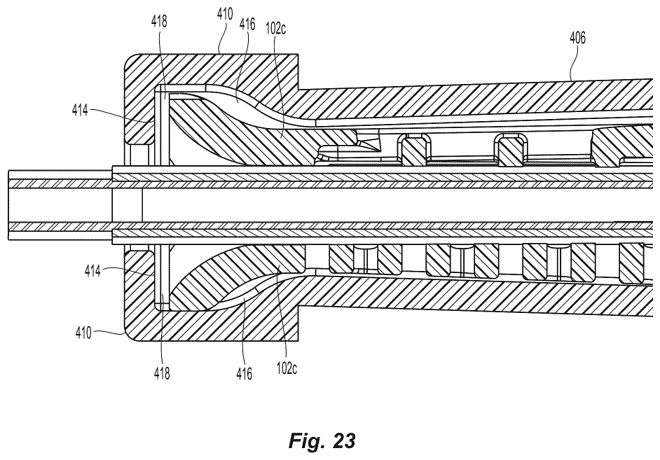

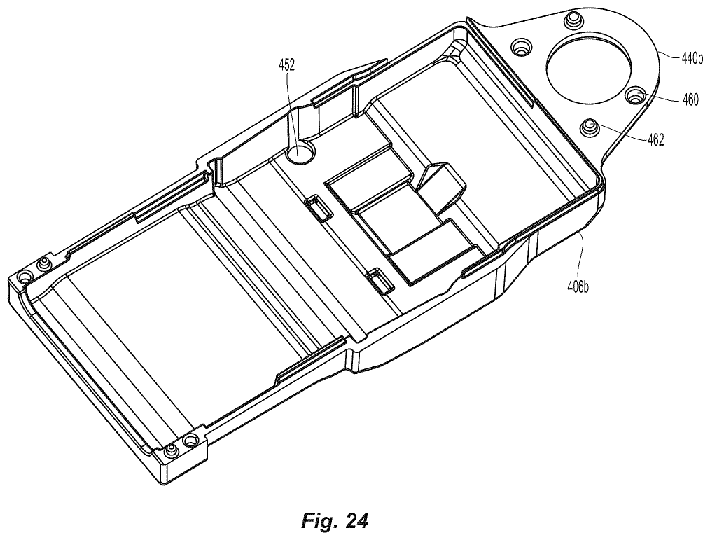

A combination 400 of a carrier 404 and a clam shell pulling eye 406 is illustrated in FIGS. 20-24. The carrier 404 is generally the same as the one illustrated in FIG. 3 for receiving at least two fiber optic connectors 102. The clam shell pulling eye 406 is a two piece element, with a top portion 406a and a bottom portion 406b. The two portions may be connected (i.e., have a hinge along one side) or be two separate portions as illustrated. The clam shell pulling eye 406 has the pulling structure 440. The pulling structure 440 may also comprise two portions 440a and 440b. The two portions of the clam shell pulling eye 406 are aligned and secured to one another by a number of projections 460 and receptacles 462. While both projections 460 and receptacles 462 are shown on each of the top portion 406a and the bottom portion 406b in a hermaphroditic arrangement (making the two portions 440a and 440b identical to reduce part count), the projections and receptacles can be the same on each portion-all projections on one and all receptacles on the other. The carrier 404 has posts 454 that engage and are disposed in openings 452 in the clam shell pulling eye 406. There are preferably posts 454 and openings 452 on both the top portion 406a and a bottom portion 406b.

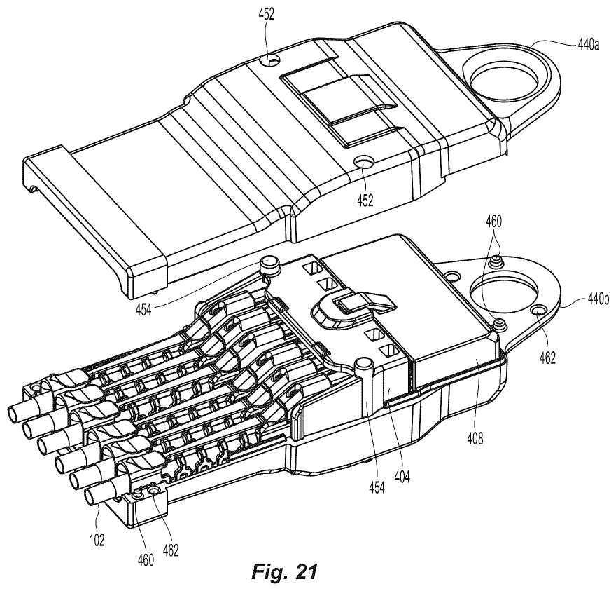

FIGS. 20 and 21 illustrate that the clam shell pulling eye 406 fully encloses the carrier 404 and the at least two fiber optic connectors 102. Thus, there is no need for a dust cap like in the other embodiments. However, an internal dust cap 408 may still be included as shown in FIG. 21.

The clam shell pulling eye 406 preferably has a shoulder 410 at the rear end 412 thereof. The shoulder 410 and a forward facing surface 414 defines a space 416 to receive a rear end of the boot 102c of the fiber optic connector 102. The rear end of the boot 102c is generally a grasping area that the worker would be utilizing with the boot 102c. There is also some extra space 418 between the forward facing surface 414 and the boot 102c of the fiber optic connector 102. This extra space assists in the arrangement of the fiber optic connectors 102 and the clam shell pulling eye 406. The clam shell pulling eye 406 may also engage the boot 102c of the fiber optic connector 102 when force is applied to the clam shell pulling eye 406 if there is movement between the carrier and the fiber optic connectors 102. There is no other component between the top portion 406a and the bottom portion 406b of the clam shell pulling eye 406 and the fiber optic connectors 102. That is the fiber optic connectors 102, and hence the latches 102a, are directly stress relieved by the contact between the other parts of the fiber optic connectors 102 and the clam shell pulling eye 406.

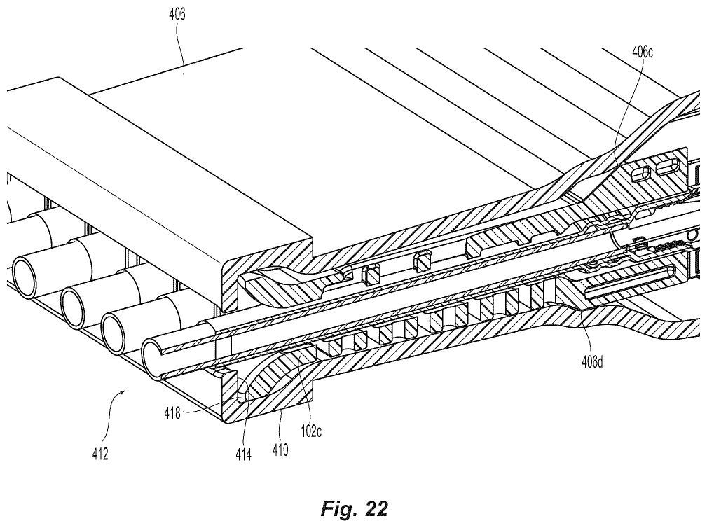

The interior of the clam shell pulling eye 406 also has contact surfaces 406c and 406d that directly engage the fiber optic connectors 102. As illustrated in FIG. 22, the contact surfaces 406c and 406d may engage the housing of the fiber optic connectors 102, although other portions of the fiber optic connectors 102 or the boot 102c may be engaged too such that a tensile force applied to the pulling structure 440 is transferred to an optical fiber cable element through the connector housing. The clam shell pulling eye 406 would move the individual fiber optic connectors 102 along with the carrier 404. However, such engagement with the fiber optic connectors would not be necessary if the posts 454 engage and are disposed in openings 452.

Various components described herein may be shipped as a bag of parts for assembly later at a different point in time and location. It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A combination of a carrier and a dust cap for at least two fiber optic connectors, the combination comprising:
a carrier having a carrier main body formed by two long sides of the carrier bound by two opposing short sides of the carrier and having a main opening along a longitudinal axis between a first side and a second side for receiving the at least two fiber-optic connectors therein;
a dust cap having a dust cap main body with an open end and a closed end separated along the longitudinal axis, the dust cap main body formed by two long sides bound by two opposing short sides and the closed end, the open end configured to receive at least a portion of the carrier and a portion of the at least two fiber optic connectors;
a pulling structure adjacent the closed end of the dust cap and extending away from the open end;
at least one attachment mechanism to couple the dust cap to the carrier.

2. The combination of claim 1, wherein the at least one attachment mechanism comprises a lever rotatably attached to the dust cap and at least one post on the carrier to couple to an end portion of the lever.

3. The combination of claim 1, wherein the at least one attachment mechanism comprises at least one cantilevered beam on the dust cap main body of the dust cap and extending away from the open end and the closed end, and wherein the carrier comprises at least one post to couple to the at least one cantilevered beam.

4. The combination of claim 1, wherein the at least two fiber optic connectors comprise at least six fiber optic connectors, and wherein the dust cap and the carrier each further comprise an internal wall, respectively, to separate three of the at least six fiber optic connectors from the remaining fiber optic connectors in the at least six fiber optic connectors.

5. The combination of claim 4, wherein the internal wall of the carrier is connected to the two long sides of the carrier, and the internal wall of the dust cap is connected to the two long sides of the dust cap.

6. The combination of claim 1, wherein each of the dust cap and the carrier further comprise respective alignment features to align the at least two fiber optic connectors.

7. The combination of claim 1, wherein the carrier includes receptacles to respectively receive latches of the at least two fiber optic connectors to secure the at least two fiber optic connectors to the carrier.

8. The combination of claim 1, wherein an end face of a fiber optic ferrule of each of the at least two fiber optic connectors is fully enclosed by the dust cap main body when the carrier is secured to the dust cap.

9. The combination of claim 1, further comprising a shroud having a main body with an opening to receive at least a portion of the dust cap and the carrier together.

10. The combination of claim 9, wherein the pulling structure is outside the opening of the shroud.

11. The combination of claim 1, wherein the pulling structure is a loop.

12. The combination of claim 1, wherein the pulling structure is a closed loop.

13. A combination of a carrier and a clam shell pulling eye for at least two fiber optic connectors, the combination comprising:
a carrier formed by two long sides bound by two opposing short sides and having a second main opening along a second longitudinal axis between a first side and a second side of the main body for receiving the at least two fiber-optic connectors;
a clam shell pulling eye having a main body to fully enclose the carrier and respective housings of the at least two fiber optic connectors, the main body of the clam shell pulling eye having an open end and a closed end separated along a longitudinal axis when two pieces of the clam shell pulling eye are joined together;
a pulling structure attached to the closed end of the clam shell pulling eye and extending away from the open end;
at least one shoulder adjacent the open end of the clam shell pulling eye, the at least one shoulder commonly enclosing respective boots of the at least two fiber optic connectors.

14. The combination of claim 13 wherein the clam shell main body includes receptacles to respectively receive posts on the carrier in an assembled state of the combination.

15. The combination of claim 13, further comprising a dust cap having a dust cap main body with a dust cap open end and a dust cap closed end separated along the longitudinal axis, the dust cap main body formed by two long sides bound by two opposing short sides and configured to receive at least a portion of the carrier and the at least two fiber optic connectors at the dust cap open end.

16. The combination of claim 15, further comprising at least one attachment mechanism to couple the dust cap to the carrier.

17. The combination of claim 15, wherein the dust cap is optional.
